(19) United States
(12) Patent Application Publication
(10) Pub. No.: US 2025/0097561 A1
(43) Pub. Date: Mar. 20, 2025

(54) Methods and Apparatus for Illuminating Areas to Facilitate Depth Determination

(71) Applicant: More, Inc., San Mateo, CA (US)

(72) Inventors: Rajiv Laroia, Far Hills, NJ (US); Divya Gupta, Redwood City, CA (US)

(21) Appl. No.: 18/369,841

(22) Filed: Sep. 19, 2023

(51) Int. Cl. H04N 23/56; G03B 21/20

(52) U.S. Cl. CPC H04N 23/56; G03B 21/208

(57) ABSTRACT

Methods and apparatus for illuminating scene areas to facilitate depth determination are described. A sequence of frames is displayed, e.g., projected, onto a scene area to illuminate the area for image capture. The sequence of frames includes a patterned frame followed by a concealing frame. The patterned frame and concealing frame are each displayed for no more than 1/60 of a second. The concealing frame maybe and sometimes does display a complementary pattern to the preceding patterned frame. When viewed sequentially by a human viewer the human sees a non-distracting uniformly illuminated scene area as a result of the effect of the concealing frame. One or more cameras are used to capture images of the illuminated area during a time in which the pattern is displayed and the scene area is effectively painted with a pattern that can facilitate depth determination based on one or more captured images.

### FIELD

The present application relates to illumination techniques and, more particularly, to methods and apparatus for illuminating one or more areas to facilitate image taking for purposes of depth determination.

### BACKGROUND

Depth is useful in a wide range of applications. Depth is often used to refer to the distance to an object from a known point or location such as a camera position or position of a LIDAR device. Accordingly, in the context of depth determinations depth and distance are often used interchangeably and such terms will be used interchangeably in various locations in the present application.

Common applications for depth determination include device control operations relating to movement of a device. For example, depth information can be used to control a vehicle or robot to avoid obstacles, move to a desired location and/or navigate in an area. For example, in the case of vehicle control depth information may be used to control the vehicle to avoid obstacles in a road or path while the vehicle travels towards a desired destination. Similarly in the case of a robotic device depth information may be used to control movement of the robotic device in a factory or warehouse and/or movement of a robotic arm or other attachment to implement an operation such as pick up or move a package. Other applications for depth information include quality control operations such as the inspection of manufactured parts for defects. Such defects can include surface defects in the form of protrusions and/or cavities in a object. For example, inspections of welds are an example of one application where depth information can be used to determine if the weld is defective.

Various techniques for determining depth exist. For example, LIDAR, an acronym of “light detection and ranging” or “laser imaging, detection, and ranging”, is a method for determining distance by targeting an object or a surface with a laser and measuring the time for the reflected light to return to the receiver. Radar is another technique for determining distance.

While such techniques can be useful, in particular applications LIDAR has the distinct disadvantage of requiring use of laser light. This can be particularly undesirable in various applications, such as in areas where humans are working and where the use of visible lasers can be distracting or even damaging to a human's eye depending on the intensity and/or duration of light exposure. In addition, LIDAR tends to produce what may be considered a low resolution depth, since it tends to produce far fewer depth measurement points than the number of pixels included in common images of a scene area. In such a case while the depth measurements may be accurate, the number of depth measurements tends to be sparse.

Radar, while not being visually distracting to humans, also has the disadvantage of producing relatively low resolution/sparse depth information, with the resolution often well below that achieved by Lidar systems and far below that achieved in many cases using stereoscopic depth determination techniques.

Thus, while radar and Lidar may be suitable for some applications, they suffer disadvantages that make them unsuitable for many applications particularly, where a large number of depth measurement points corresponding to an area or surface are desired.

Other ways of measuring depth often involve the use of cameras to capture images and analysis of captured images to determine depth, e.g., distance from a camera or known position relative to a camera used for image capture.

One technique for determining depth involves projecting a known geometric pattern showing an expanding grid or other set of fixed lines, e.g., straight and/or curving lines having a known spatial relationship. An image of the projected geometric pattern is captured using a camera, and the position of objects relative to the lines in the projected information provides rough position and thus distance information in some applications. Such systems can be implemented using a single camera and generally do not involve determining differences between images captured by different cameras, as is the case in stereoscopic depth determinations.

Because projected line patterns can be distracting to humans if they are visible, systems which depend on the projection of a line pattern often rely on the use of infrared light which is not visible to the human eye. While infrared cameras are available, they tend to be less common than visible light cameras and the need for infrared light sources and cameras can add to the cost of some products. More significantly however, such approaches which depend on the projection of lines to facilitate depth determination often result in high latency and/or low resolution results and limited range, which is not suitable for many applications.

Stereoscopic depth determination is a technique sometimes used to determine depth and often has the advantage of relatively high resolution in terms of the number of points for which depth can be determined in a given scene area. In at least some stereoscopic depth determinations two or more cameras, which are separated from one another, each capture an image of a scene area. The output of the cameras provides at least two different images of a scene area, corresponding to different camera positions, which can be compared. Differences between the images can be used to make depth determinations. As part of a stereoscopic depth determination process, portions of the images captured by different cameras, e.g., sets of pixels from each image, are compared. Information about the difference in the location of matching sets of pixels in the different images is used to determine distance to surfaces, e.g., surfaces of objects, in the captured images. A depth map in some cases is generated in the form of a set of distance values with each distance/depth being associated with a different pixel of a camera image, e.g., a reference camera image. Thus in at least some cases the depth, indicated in the depth map, indicates the distance from the reference camera to the object captured in the image, to which the pixel corresponds.

A depth map, generated using stereoscopic techniques, has the advantage that a depth can be determined for each pixel of an image in at least some cases. This stereoscopic based approach can often produce a much more detailed depth map than Lidar or radar, given the relatively large number of pixels in images captured by even low cost cameras that are available today.

While stereoscopic depth determination offers the possibility of a relatively high resolution/dense depth determination as compared to some other techniques, it often depends on the ability of capturing good quality images of a scene area for which depth determinations are to be made. In many locations, such as indoor applications, ambient light may not provide sufficient lighting for stereoscopic depth determinations. For example, while warehouse lighting might be satisfactory for human workers to perform warehouse tasks, normal warehouse lighting may be unsuitable for capturing images using many visible light cameras without additional lighting.

While simply adding bright ceiling lights or other lights to an area, e.g., a warehouse, might seem like a solution to the lighting problem associated with stereoscopic image capture, the use such lights can introduce problems in terms of reflections and/or result in the bright light saturating portions of a camera's image sensors.

Plastic wrap is commonly found on boxes or other packages. Reflections can occur due to the use of such plastic wraps or simply the presence of other reflective surfaces in a warehouse. In such a case the reflection of a bright ceiling light can overwhelm a camera sensor. In addition, direct reflections from lights may result in stereoscopic depth techniques determining the distance to the light source that is reflected from an object rather than the distance to the object reflecting the light.

While light reflection from bright ceiling lights or other light sources are one problem for stereoscopic depth determinations, large uniform surfaces present another problem. Such surfaces can often be found in a variety of indoor and outdoor environments. For example, walls of buildings and rooms are often painted a uniform color or boxes of uniform color are stacked together. Since stereoscopic depth determination involves matching a small region in one image to a corresponding region in another image areas of uniform color can make the pixel matching process difficult and often lead to inaccurate results with mismatches being made between areas in the different images. Thus, uniform surfaces appearing in images can, and sometimes do, lead to errors in depth/distance predictions.

For stereoscopic depth determination purposes, it is desirable that captured images have variation within the image. While painting walls or surfaces to be non-uniform in appearance may facilitate stereoscopic depth determinations, such painting can be costly and, in some cases, may lead to an appearance which is unsightly or distracting to people working in the area where such painting is applied.

From the above it should be appreciated that stereoscopic depth determination can be desirable for many applications, but that there is a need for improved methods of illuminating an area to facilitate stereoscopic depth determinations. It would be desirable if methods and/or apparatus could be developed which could be used to facilitate stereoscopic image capture and/or stereoscopic depth determinations.

It is desirable that at least some of the methods and/or apparatus operate using visual light and/or visible light cameras without causing distractions to humans in the area.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram showing an exemplary apparatus including an illumination device and image capture system implemented in accordance with one embodiment of the invention in an environment where the apparatus may be used.

FIG. 2 and FIG. 3 are diagrams showing the exemplary apparatus shown in FIG. 1 in greater detail.

FIG. 4, FIG. 5 and FIG. 6 are diagrams showing exemplary complimentary image patterns which are used in some embodiments as images which are displayed, e.g., sequentially, as part of an illumination process intended to facilitate depth determination.

FIG. 7, FIG. 8, FIG. 9 and FIG. 10 show image/pattern sequences used for illumination purposes in accordance with various exemplary embodiments.

FIG. 11, FIG. 12 and FIG. 13 are diagrams showing additional exemplary complimentary image patterns, at least some of which are color image patterns, which are used in some embodiments as images which are displayed for illumination purposes.

FIG. 14 shows a flow chart of a method implemented in accordance with the invention involving illumination and depth determination based on captured images of an illuminated area.

### SUMMARY

Various features relate to methods and apparatus for illuminating an area by projecting image patterns that are well suited for facilitating depth determinations in a manner that is not distracting and with the projected image patterns often being imperceptible to a human observer.

In some cases, this involves projecting a first illumination pattern followed by projecting a second different illumination pattern, sometimes referred to as a concealing pattern, with each pattern being projected for a fraction of a second, e.g., 1/60th of a second or less.

The first illumination pattern and concealing pattern form a concealing image pair sometimes referred to as a complimentary image pattern pair or complimentary images. In some embodiments complementary images are first and second images, i.e., a pair of images, where each of the complementary images is different from the other image in the image pair. In some but not necessarily all embodiments complementary images are images that, when pixels values corresponding to the same location but from different ones of the complementary images are added together, have a uniform intensity or have a locally uniform intensity, e.g., with the summed pixel values in a local region, e.g., 16×16 pixel square region, having summed values within 70% of each other. In some but not necessarily all embodiments complimentary images have pixel values, which when summed together on a per pixel location basis, have a time-average intensity (e.g., summed value) that is within 30% of a target intensity which can and sometimes is expressed as a pixel value. In the case of color pixel values where there are multiple color channels, the summing of pixel values is on a per color channel basis, with an R value of a first image being summed with an R value of a second image to determine if the R value is within 30% of a target R value. In many embodiments a pattern is visible to a human observer in each complementary image when viewed by itself but when viewed consecutively for less than 1/60th of a second per frame, the second image in the pair of images conceals the pattern in the first image to a human viewer.

While a camera or cameras can, and in some embodiments does or do, capture each illumination pattern separately, a human viewer interprets the patterns as a single composite image. By using a concealing pattern, which is complementary to the initially displayed illumination pattern, a human observer will observe uniform illumination of the scene area onto which the illumination pattern and concealing illumination pattern are projected.

By projecting a sequence of patterns and capturing one or more images of the patterns, images well suited for depth determination are obtained. The image or images captured during an illumination period corresponding to a frame display time, e.g., a 1/60 of a second, which is a period in which projection of a pattern occurs, are used to make depth determinations.

The determined depth to objects, e.g., as indicated relative to a reference camera or other fixed location relative to a camera, are used in one or more operations, e.g., machine control operations and/or 3D modeling operations. For example, the determined depth information can be, and sometimes is, used to control a robotic device, e.g., warehouse robot, to perform a pick operation, e.g., picking of an item from a rack, for shipment to a customer as part of an order. In another case, the depth information is used to control a machining operation or other operation, e.g., as part of a manufacturing operation. Other applications for depth information, generated in accordance with the invention, can include inspection of items for quality control and/or other reasons.

Since the individual illumination patterns, which are displayed sequentially for illumination purposes, are not detectable to a human observer and will be interpreted by the human observer as a composite of the sequentially displayed illumination patterns and interpreted as uniform illumination of a scene area, the illumination process can be safely used in environments where humans are present without causing unwanted distractions. In fact, the illumination can even be effective in increasing work area safety by increasing the general illumination in an area.

In some embodiments one or more cameras, used to capture images, are synchronized based on an electrical or other signal, e.g., wireless signal, sent from the illumination device to the camera(s) used to capture images. This is to synchronize image capture time with the display of an individual image, thereby allowing the camera to capture images of the individual patterns displayed, with each captured image frame corresponding to a displayed image pattern once illumination device and camera device synchronization has been achieved. While electrical/wireless synchronization is used in some embodiments to synchronize illumination pattern display and image capture, in other embodiments images are captured, and the captured images are used to achieve camera synchronization with the display rate of the illumination device. For example, this is done in some embodiments by shifting image capture time, e.g., frame capture, so that the energy in each frame capture time, in which a pattern is displayed for depth determination purposes, is the same or approximately the same. Such an approach is well suited for embodiments where images used as illumination images display patterns which, in both the initial and subsequent concealing image, provide the same amount of illumination despite displaying very different patterns, e.g., with the concealing image being complementary to the initial image pattern displayed in the preceding frame.

In some cases, a non-patterned image, e.g., uniform image, is displayed between sets of patterned images intended to support depth determination purposes. The non-pattern image allows an image of objects in an area to be captured without a pattern being displayed on them as part of the illumination process. Images captured during a non-patterned illumination period can be, and sometimes are, stored for use in supporting objection recognition training operations where a non-patterned image is used. The non-patterned image can be, and sometimes is, associated with one or more corresponding patterned images. This allows depth information generated for an object, captured in a patterned image, to be correlated or otherwise associated with an image of the same object, captured in a non-patterned image captured during an illumination period in which a pattern is not displayed but illumination is still provided by the illumination device. In some embodiments the non-patterned image, e.g., uniform illumination image, is generated with the same overall average light output as an individual image used to display a pattern. Thus, on a per pixel basis, in some cases, each pixel of the non-patterned image is half as bright as the “on” pixels of a patterned image. This is because, in some cases, half of the pixels of a pattern image are “on”, e.g., white, while the other half of the pixels of the pattern image are “off”, e.g., black, while in the non-pattern image all the pixels are on but set at an image intensity, which is intended to result in the same overall light output of an image displaying a pattern, e.g., where only half the pixels are “on”.

While the projected image patterns may be unobservable to a human viewer, they are useful in facilitating depth determinations because the patterns can be captured by one or more cameras in an area. Where the projected image pattern includes structured lines, e.g., a set of straight and/or curved lines, a single camera may be used to make depth determinations from one or more captured images. In the case of stereoscopic depth determinations, two or more cameras, at physically different locations, are often used to capture images with differences between the captured images being used to determine depth.

While line patterns can be displayed using the methods of the present invention in a way that is not easily perceived by a human, and thus in a manner that is not distracting to human observers, in many cases the displayed patterns are not line patterns but rather patterns which are more random in their nature. Such patterns, which appear random or pseudo random in nature, are particularly well suited for use in supporting stereoscopic depth determinations, where the displayed image patterns are captured by two or more cameras at the same time, and the images captured by the different cameras are used for stereoscopic depth determination purposes.

In various embodiments the illumination pattern and complementary pattern have one, more of all of the following features:
i. The patterns displayed as part of the illumination process are concealed to a human viewer when averaged over time.
ii. The individual image patterns displayed during individual illumination/frame display times have a texture pattern that makes it easier to match portions of an image pattern captured by different cameras to facilitate stereoscopic depth determination. For example, in one exemplary embodiment the texture includes a random noise pattern which has an impulsive autocorrelation function so that the pattern included in a displayed image produces a sharp minima in a cost function used in comparing image portions of different captured images which can lead to a more accurate and precise match between portions of different images as compared to when other image patterns are used for depth determination purposes.
iii. The pattern of an individual frame displayed for depth determination purposes has a gradient over the image for complexity reduction during matching of image portions of different captured images as part of stereoscopic depth determination. The gradient can be, and sometimes is, a gradient in the average local intensity values of one or more channels in the image where the channels can be, for example, color and/or luminance channels. In some embodiments the gradient direction in a pattern matches a stereo baseline orientation, e.g., horizontal or vertical, with in some embodiments, the illumination pattern of an image having a horizontal gradient. The gradient in some embodiments can repeat within an image pattern.

Various embodiments can include one or more of the above-described features. Thus, it should be appreciated that not all embodiments include the full set of features discussed above.

Numerous variations on the above-described methods, apparatus and applications are possible with details of various exemplary embodiments discussed below in the detailed description which follows.

### DETAILED DESCRIPTION

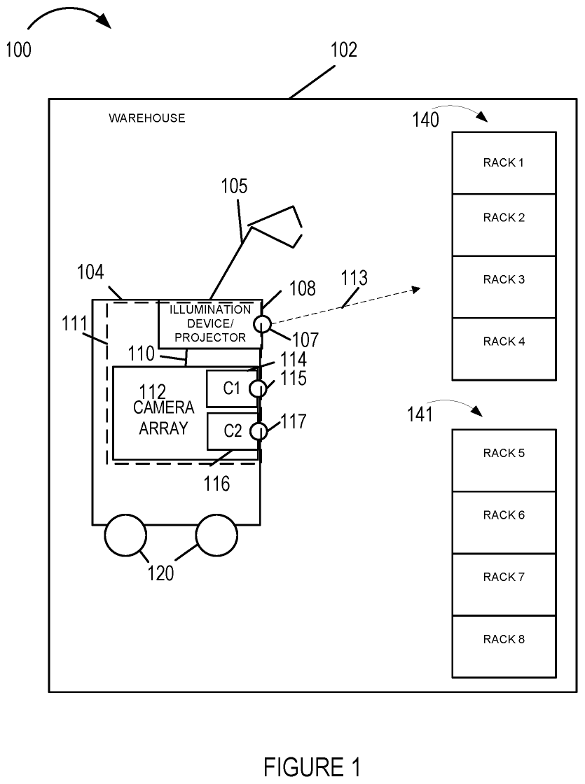

FIG. 1 is a diagram 100 showing a warehouse 102 in which a robotic device 104 with a controllable arm 105 and wheels 120 can move. The warehouse 102 includes a first set of racks 140 and a second set of racks 141 including shelves on which boxes or other items are stored and which can be picked or moved by the robotic device 104, e.g., to satisfy a customer order.

While explained in the context of a robotic device, it should be appreciated that the illumination system and/or camera capture system can be used in a wide variety of application including station applications such as where monitoring of items, e.g., manufactured products, is performed for quality control purposes or where a stationary robot used in manufacturing items is located. In such cases the illumination device 108 and/or camera array 112 may be mounted in a stationary or movable mount which can be part of or separate from the robot or other device in the area being monitored. In some embodiments the robotic device 104 is a vehicle with a pick arm 105.

The robotic device 104 includes an illumination and stereoscopic camera system 111 implemented in accordance with the invention. The illumination and stereoscopic camera system 111 includes an illumination device 108 and one or more cameras C1 114, C2 116. The illumination device 108 in some embodiments is a light projector which can project images through lens 107. The images are in the form of frames which display a pattern. The displayed images are used in accordance with the invention to illuminate an area, e.g., a portion of the warehouse 102 including the racks 140 on which boxes may be, and sometimes are, positioned. In some embodiments the illumination device 108 is collimated light projector, but collimated light is not used in all embodiments. The system can include multiple illumination devices. In some embodiments the system 104 includes a second illumination device/light projector (ID/LP2) 109 in addition to the first illumination device 108. The individual illumination devices 108, 109 are each positioned in some embodiments adjacent to one of the multiple cameras 114, 116. Thus, in some embodiments each camera 114, 116 is paired with a physically adjacent light projection device 108, 109. Both light projection devices 108, 109 can be and sometimes are implemented in the same manner. The light projection devices 108, 109 can output the same or different images. In some embodiments the light projection devices 108, 109 each include multiple light emitting elements 103, 105.

In some embodiments in which collimated light is used the rays 113 of light are directed at an angle which is not a right angle (an angle which is not a 90 degree angle) relative to the vertical and horizontal surfaces in the warehouse 102 to reduce the risk of reflections of light off the vertical and horizontal surfaces being reflected directly into the lenses 115, 117 of the cameras C1 114, C2 116 from the walls, floor, ceiling and sides of boxes on the racks 140, 141.

The light projector 108 is shown coupled to the camera array 112 by connection 110. The connection 110 can be a wired or wireless connection and is optional. The connection 110 is used in some embodiments to synchronize the light projector display frame rate with the image capture rate of the cameras C1 114 and C2 116 of the camera array 112. While two cameras are shown, more cameras may be used, and the camera array 112 includes 3 or more cameras, in some embodiments, to facilitate stereoscopic image capture. In cases where structured lines are projected and stereoscopic depth determination is not used, a single camera C1 114 may be used instead of multiple cameras C1 114, C2 116.

While the illumination device 108 and cameras C1 114, C2 116 are facing in the same general direction, the illumination device 108 directs light 113 in a direction intended to minimize the chance of direct reflections being returned into the cameras C1 114, C2 116.

In some, but not necessarily all, embodiments a Collimated light projector 108 is used to project the image patterns using visible light. The parallel or generally parallel light 113 output by the Collimated light projector reduces the risk of unwanted reflections from the light projector directly back into one or more camera lenses used to capture images. To further reduce the risk of reflections directly into a camera, in some embodiments, the illumination source 108 is directed so that it projects light at an angle, other than a 90 degree angle, relative to the vertical and horizontal planes of the environment in which illumination and observation operations are being performed. This is because in real world environments walls, ceilings and floors, as well as racks and stacks of boxes often tend to have flat horizontal or vertical surfaces, e.g., relative to the ground, off of which light can reflect. By directing light at an angle to such surfaces, light reflected by such surfaces is likely to be directed away from the cameras used to collect such light rather than directly into the cameras particularly where the cameras and illumination device are mounted on the same apparatus and oriented in the same or generally same direction. While light reflected by surfaces preferably does not get reflected directly back to the camera, light diffused by illuminated surfaces will be captured by the camera(s) and is well suited for use in making depth determinations.

Thus, in some embodiments the illumination device 108 which may be, and sometimes is, a light projected is oriented in a manner that reduces the risk of reflections directly back into the camera and increases the chance that light diffused by the surface of objects illuminated by the light projector will be captured and observed without overwhelming the sensor of the camera(s).

In some embodiments, there may be multiple light projector devices that are used to illuminate a scene. The light projector devices may or may not overlap in certain regions. There is no requirement for the light projectors to be synchronized with respect to each other or with respect to the camera for stereo depth determination. In some embodiments, one or more light projector devices may be set to the same display rate or a multiple of the other light projector devices so that a non-stereo camera system can observe a uniform illumination pattern by setting an appropriate exposure time and without overexposing the image. In some embodiments, the light projector devices and cameras may be synchronized to achieve maximum pattern contrast. In some embodiments, the projectors may be synchronized to display the same non-pattern frame so that an image can be captured by a non-stereo camera system.

The location of the projector(s) relative to the camera need not be calibrated or even fixed for a stereoscopic system. It can be advantageous to locate the projector as close as possible to the one of the cameras used for depth determination, ideally the camera used as a reference camera when making depth determinations. This positioning is in order to have maximal overlap between the shadow regions created by the projector (where the pattern illuminated by the projector is not visible in the scene and cannot aid depth determination) and the occlusion regions of the camera. In some embodiments, the projector optics and orientation may be selected such that the display region of one or more projectors approximately matches the field of view of the camera so that the projector pattern can aid depth determination across the whole image. In some embodiments, the projector design may be selected so that the illuminated area covers a region of the image where depth determination is most relevant or most challenging.

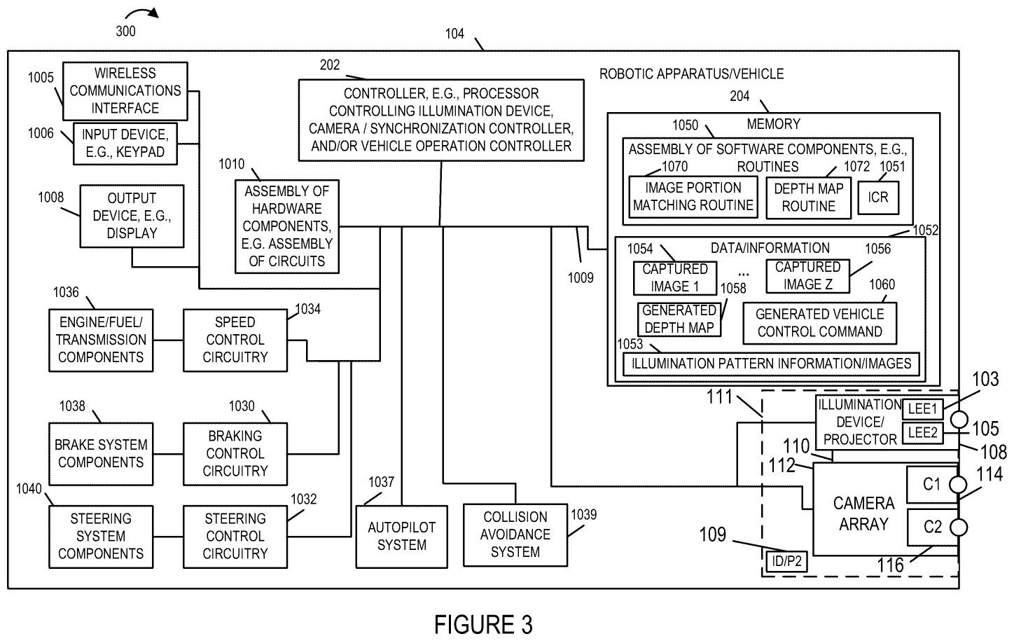

In the FIG. 3 example, the illumination devices 108, 109 are physically adjacent the cameras 114, 116 so that the illumination area of each illumination device closely matches the image capture area of the corresponding camera or pair of cameras 114, 116. In some embodiments a single illumination device 108 is used but more than one illumination device maybe used.

While a collimated light source 108 is used in some embodiments, in other embodiments the illumination device 108 is a simple projector, e.g., a digital or analog projector, capable of projecting the patterns to be used for illumination purposes and to support depth determinations.

It is advantageous for the projection device to match the scanning mode of the capture device. For a global shutter capture device, it is best for the projector to display all pixels in the image as a global update (or have a fast enough scan rate to appear as a global update) rather than by sequentially updating every row or column in a rolling or scanning fashion. Otherwise, the projected image may show the original pattern in one portion of the image and the concealing pattern in the other. In some embodiments, this may be realized by using a digital micromirror device (DMD) which uses an array of tiny mirrors to direct light produced by an illumination source (e.g. lamp, LED, laser, etc.) and may pass through a spinning color wheel, through a lens. For a rolling shutter capture device, the projector should be progressive scanning and the devices should be synchronized to time image capture.

While the cameras are shown as coupled to the illumination device 108 to facilitate synchronization, in some embodiments the cameras do not receive sync signals from the illumination device 108 and instead capture images independently. In some such embodiments camera sync may be, and sometimes is, achieved with the illumination device 108 based on processing of captured images.

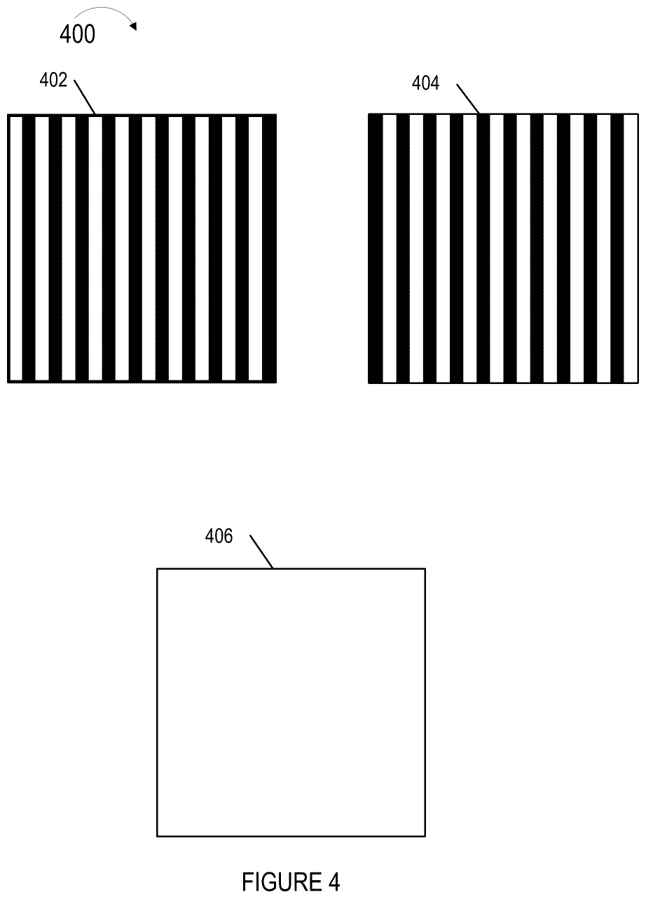

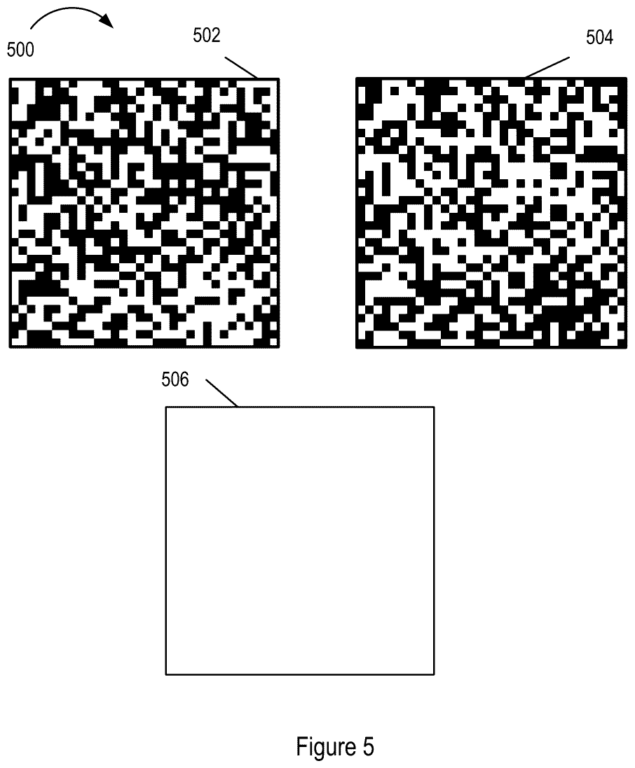

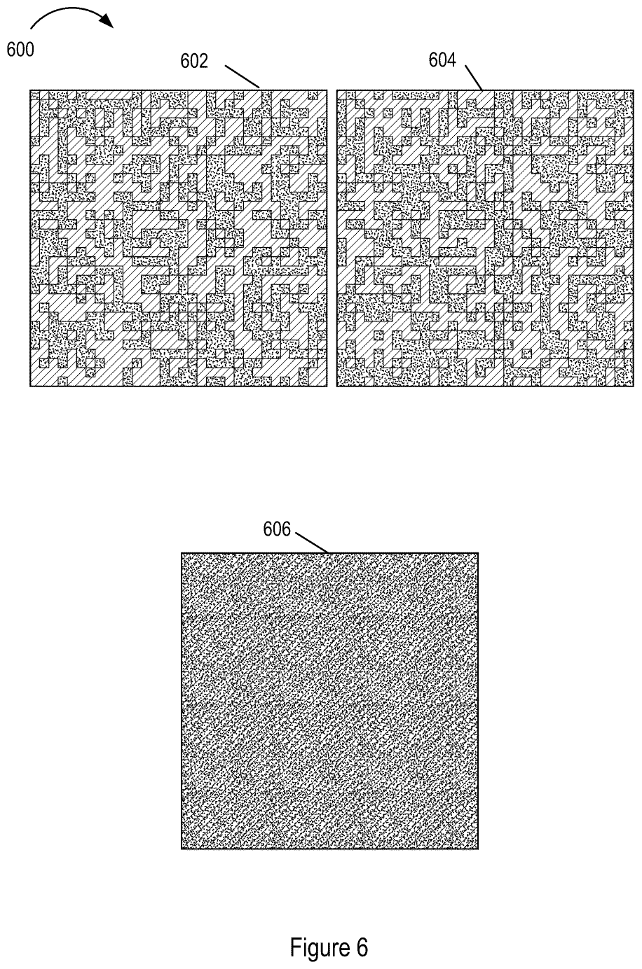

In accordance with some embodiments a first image pattern is projected by the illumination device 108 followed by a second image pattern with each pattern corresponding to a displayed frame being projected for a fraction of a second, e.g., less than 1/60 of a second. Various patterns which can and are displayed in accordance with some embodiments are shown in FIGS. 4-13 which will be discussed in detail below.

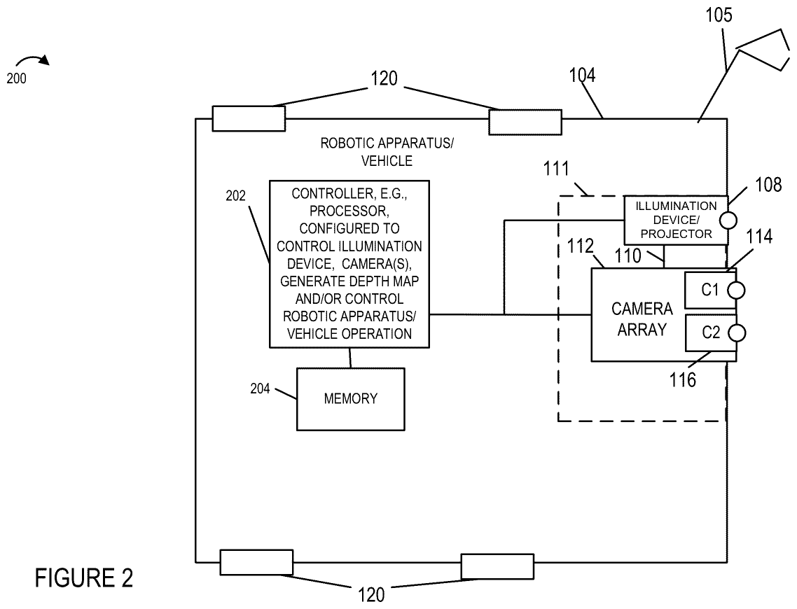

FIG. 2 is more detailed drawing 300 of the robotic apparatus/vehicle 104 shown in FIG. 1. The apparatus 104 includes a controller 202, e.g., a processor coupled to a memory 204 and the illumination/camera system 111 of FIG. 1.

The apparatus 104, e.g., robotic device/vehicle, supports illumination of a scene area and image capture using one, but in many cases, multiple cameras. The apparatus 104 performs image processing in accordance with the invention to identify matching portions of images and to produce depth information, and performs vehicle control vehicle operations based on the depth information obtained from the image processing. While in some embodiments the apparatus 104 performs image processing and depth determination using online processor 202, in other embodiments captured images are communicated, e.g., wirelessly, to a web or cloud based system for processing and depth determination operations with in some cases depth information being returned to the apparatus 104 and used by the processor 202 for device control.

FIG. 3 is another drawing 300 of the exemplary apparatus 104, e.g., robotic device or vehicle which supports illumination and image capture for depth determination purposes with still more details shown. Exemplary apparatus 104 includes a plurality of cameras, camera 1 (C1) 114, camera 2 (C2) 116 which are part of the camera array 112. The cameras capture images of the scene area illuminated by illumination device 108 in accordance with the invention. Exemplary vehicle 104 further includes controller 202, e.g., a processor, configured to control illumination and camera operation including camera synchronization with the output, e.g. displayed images, of the illumination device 108. The controller 202 is configured to identify matching portions of images to produce depth information, generate a depth map, and/or control vehicle operation. Memory 202 stores illumination pattern information 1053 which includes the patterns, e.g., first and second images, to be displayed and the sequence in which the patterns are to be displayed for illumination purposes. A wide variety of patterns, e.g., black and white and/or color pixel patterns can be stored in information 1053 and displayed e.g., by illumination device 108, as part of a video sequence used for illumination purposes. The patterns which are images may be stored in a variety of data formats depending on the embodiment and need not be stored as a bitmap but can be stored as equations or other data used to render the images to be displayed as part of the illumination process.

The first camera C1 114 and second camera C2 116 are mounted on apparatus 104 facing in the direction of the scene area that is illuminated by illumination device/projector 104. Controller 602 is coupled to each of the cameras (C1 606, C2 608, C3 610, C4 612). Controller 202 controls the illumination device 108 to illuminate a scene area, e.g., by sequentially displaying image patterns in accordance with the information stored in illumination pattern information 1053, while cameras 114, 116 are controlled to capture images of the illuminated scene area.

Controller 202 receives images captured by each of the cameras (C1, C2) during an frame time in which a pattern is displayed by illumination device 108. In some embodiments controller 202 identifies matching portions of images corresponding to the same frame time, e.g., captured from different cameras at the same time, and uses the information about which portions match to determine depth to objects in the scene area. Thus, in some embodiments controller 502 uses matching portions of images to produce depth information and generate a depth map.

In other embodiments controller 202 causes captured images to be communicated, e.g., wirelessly via wireless communications interface 1005, to a cloud or network based image processing system. The cloud or network based image processing system processes the communicated images and returns a depth map to the apparatus 104 to be used for device control.

In some embodiments, controller 202 controls a vehicle control operation, e.g., one of a direction, braking, or speed control operation, to be performed in response to a generated depth map. In various embodiments, controller 202 uses the depth map information to perform collision avoidance operations and/or perform autopilot operations.

Exemplary vehicle 104 shown in FIG. 3 will now be discussed further. Apparatus 104 includes the processor 202, e.g., a CPU acting as a controller, e.g., illumination device controller. a camera/synchronization controller and/or vehicle operation controller, an input device 1006, e.g., a keypad, an output device 1008, e.g., a display, an assembly of hardware components 1010, e.g., an assembly of circuits, memory 202, the plurality of cameras (camera 1 114, camera 2 116), speed control circuitry 1034, braking control circuitry 1030, steering control circuitry 1032, an autopilot system 1037, and a collision avoidance system 1039 coupled together via a bus 1009 over which the various components may interchange data and information. In some embodiments, the autopilot system 1037 and/or the collision avoidance system 1039 are coupled together and/or to the speed control circuitry 134, braking control circuitry 1030 and/or steering control circuitry. Vehicle 1000 further includes engine/fuel/transmission components 1036, e.g., a motor, internal combustion and/or electric, computer controlled fuel injection system, electronically controlled transmission, etc., which is coupled to speed control circuitry 1034. Vehicle 1000 further includes brake system components 1038, e.g., ABS system, brake sensors, wheel motion sensors, wheel position sensors, actuators, hydraulic components, electronically controlled brakes, etc., coupled to braking control circuitry 1030. Vehicle 1000 further includes steering system components 1040, e.g., rack and pinion unit, steering input controls and steering drive components including motors, etc., coupled to steering control circuitry 1032. In some embodiments, the steering control circuitry 1034, braking control circuitry 1030 and/or steering control circuitry 1032 is part of an autonomous or semi-autonomous driving control system and/or an assisted driving control system. A wireless interface 1005, e.g., including a wireless radio transmitter and receiver, which allows the controller 202 to communicate captured images to a cloud based image processing system and to receive depth map information generated from captured images back from the cloud based system.

Memory 1012 includes an assembly of software components 1050, e.g., an assembly of software routines or software modules, and data/information 1052. Assembly of software components 1050 includes illumination control routine (ICR) 1051, an image portion matching routine 1070 and a depth map routine 1072. ICR 1051 when executed by controller 202 controller 202 controls the apparatus to display a sequence of images, indicated in stored illumination pattern information 1053 by causing the illumination device 108 to output, e.g., display the image patterns in sequence.

Data/information 1052 includes captured images (captured image 1 1054, . . . , captured image Z 1056), a generated depth map 1058, e.g., generated from captured images, and a generated vehicle control command 1060, e.g., to be sent to speed control circuitry 1034, braking control circuitry 1030, steering control circuitry, autopilot system 1037 and/or collision avoidance system 1039, e.g. in response to a detected change and/or problem, detected by analyzing the generated depth map, e.g., a stopped or disabled truck suddenly is detected in front of the vehicle resulting in a control command for avoidance.

Apparatus 104 can be any of a wide range of devices including any of: a robotic device, a land vehicle, e.g., a car, truck, motorcycle, bicycle, train, unmanned terrestrial vehicle, etc., a sea or water vehicle, e.g., boat, ship, unmanned water vehicle, etc., amphibious vehicle, air vehicle, e.g., airplane, helicopter, glider, unmanned aerial vehicle, etc.

The upper portions of FIGS. 4-6 and 11-13 show drawings 400, 500, 600, 1100, 1200, 1300 that show various frame sequences which can be used to illuminate a scene area in accordance with the invention.

The frame sequences shown in FIGS. 4-6 and 11-13 includes a first frame F1, which displays a first pattern P1, followed by a second frame F2, which displays a second pattern P2. The second frame F2 is sometimes referred to as a concealing (M) frame since it helps conceal from a human viewer the pattern P1 by displaying a complementary image pattern P2 which helps conceal the first pattern P1. The displayed image sequence repeats over time, e.g., in a periodic manner in some embodiments.

Each square in FIGS. 4-6 and 11-13 is intended to correspond to an individual pixel of an image in some embodiments but may and often will correspond to a group of adjacent pixels in other embodiments. The number of adjacent pixels used to correspond to a square may and often will depend on the resolution of the projector and/or the ability of the cameras 114, 116 to detect the pattern when projected with the number of pixels being selected so that the pattern will be detectable in the captured images. While a small number of squares are shown this is for illustration purposes and it should be appreciated that the displayed image patterns used for illumination purposes will likely include many more pixels than the number shown in the figures.

Each of the frame sequences includes a pair of frames (402, 404) (502, 504), (602, 604). (1102, 1104), (1202, 1204), (1302, 1304). The first frame (402, 502, 602, 1102, 1202, 1302) in each sequence includes a first illumination pattern while the second frame includes a concealing illumination pattern (404, 504, 604, 1104, 1204, 1304) also referred to as a complementary image pattern.

The square (406, 506, 606, 1106, 1206, 1306) in lower portion of each of FIGS. 4-6 and 11-13 represent the composite of the two patterns shown in the upper portion of the corresponding figure and is intended to convey an idea of the generally uniform illumination pattern that would be perceived by a human viewer when the patterns shown in the upper portion of the figures are shown sequentially, e.g., with each pattern being displayed by the illumination device 108 for 1/60th of a second or less. It should be appreciated that while a human viewer of the image sequence shown at the top of the figures would perceive generally uniform illumination of a scene area while the cameras 114, 116 will capture images of the scene area illuminated with the patterns shown in the top of the figures. During each frame time multiple images of each pattern will be captured, e.g., with one image being captured by each of the cameras in the array. For example, camera 114 and camera 116 will each capture an image of the illuminated scene area from different perspectives during a frame time period in which a pattern is displayed by illumination device 108. Thus cameras 114 and 116 will each capture an image of the illuminated scene area illuminated by the first pattern. They will then capture images of the illuminated scene area with the second concealing pattern. From the perspective of the cameras 114, 116 it will appear as if the illuminated scene area were “painted” with the first pattern and then “painted” with the second pattern. From the perspective of a human observer the patterns will not be observable.

The pair of images captured during a single frame time is sufficient for stereoscopic depth determination purposes. Thus, where images of patterns are captured at a given frame rate, depth maps can be and sometimes are generated at the corresponding frame rate.

In various embodiments the pattern shown in a frame used for illumination purposes where stereoscopic depth determinations are to be made should and sometimes do have one, more than one, or all of the following characteristics:
i. The pattern is concealed when averaged over time with a concealing frame pattern.
ii. The pattern has lots of texture so that it is easy to match. Various examples shown in the figures, show a random noise pattern which has an impulsive autocorrelation function so it produces sharp minima in the cost function used to compare portions of different captured images which leads to more accurate and precise matches when matching is performed between image portions of different images for stereoscopic image determination purposes. There are many different patterns which can be used and the illustrated patterns are merely exemplary.
iii. The pattern has a gradient over the image for complexity reduction during matching. This could be a gradient in the average local intensity values of one or more channels in the image displaying the pattern, where the channels can be color and/or luminance channels. The gradient direction should and in some embodiments does match the stereo baseline orientation (e.g., horizontal baseline should and sometimes does have a horizontal gradient while a vertical baseline should and sometimes does have a vertical gradient). The gradient can repeat within the image pattern.

Various exemplary initial illumination patterns and corresponding complementary patterns will now be discussed with regard to FIGS. 4-6 and 11-13.

FIG. 4 shows a first line pattern 402 and corresponding concealing line pattern 404. The line patterns 402, 404 are particularly useful when structured light based depth determinations are to be made as opposed to more complicated stereoscopic depth determinations. When a scene area is illuminated sequentially by patterns 402, 404, e.g., with each pattern being displayed for 1/60th of a second or less, a human viewer will perceive uniform illumination such as shown in diagram 406 and the patterns 402, 404 will not be perceived but they will be captured by one or more cameras 114, 116. When structured light depth determinations are used to determine distance a single camera 114 can be used and the second camera can be omitted from the apparatus 104. While the illumination pattern shown in FIG. 4 is suitable for structured light depth determinations, more complicated and more random patterns are preferable for supporting stereoscopic depth determinations.

FIG. 5 shows one example where black and white image patterns 502, 504 are used to illuminate a scene area for stereo scope depth determination. Note that in concealing image pattern 504 areas which were white in image pattern 502 are black. Similarly, in concealing image pattern 504 areas which were black in image pattern 502 are white. Thus, concealing image 504 when used immediately following image 502 will conceal from a human viewer the image pattern 502 and result in a human viewer perceiving uniform illumination of the scene area as represented by box 506. Note that in each of the initial image pattern 502 and the concealing image pattern 504 the same number of pixels are on and the same number of pixels are off resulting in uniform illumination.

Assuming a pixel value of 0 was used to represent an off state and assuming a pixel value of 255 represented a full on state, summing corresponding pixel values of each of the images would result in a value of 255 corresponding to the pixels of the image 506. However, given that each frame 502, 504 corresponds to half of the time to which image 506 corresponds, the illumination perceived by a human would be only half that which would be perceived if all of the pixels were fully on in both frames used to display patterns 502, 504.

The ideas relating to an initial illumination pattern displayed as a first frame followed by a concealing pattern displayed as a second frame can be extended to color patterns. In the case of some color patterns each pixel corresponds to the output of three different color elements, a red element, a green element and a blue element. The composite image that will be perceived as a result of using an initial color pattern and a complementary concealing pattern will result in a uniform image being perceived but with the uniform illumination being potential white or some shade of color. In the case where separate R, G and B control values are used for individual pixels of an image, the sum of an R pixel value of the initial image 602 and the corresponding pixel of the complementary image 604 will result in a consistent value throughout the image. This similarly be true if the control value of a G pixel element of the image 602 is summed with the corresponding control value of a G pixel element of the corresponding location in the concealing image 604 with the sums of the G pixel values at corresponding locations resulting in a consistent value over the entire image. Similarly, if B pixel element control values are summed for a given location in images 602 and 604 it will result in the same value for each of the pixel locations.

In FIG. 6, slanted lines are used to represent a first color while stippling is used to represent a second color. The resulting viewed illuminated scheme area will appear to a human observer to have been painted or illuminated with a consistent color, e.g., white or some other color, as shown in block 606 which will be the composite of the colors used for the individual pixel areas of frames/patterns 602, 604 while a camera capturing an image corresponding to frame time 602 will detect the color pattern shown in frame 602 and a camera capturing an image corresponding to frame time 604 will capture the color image shown in block 604.

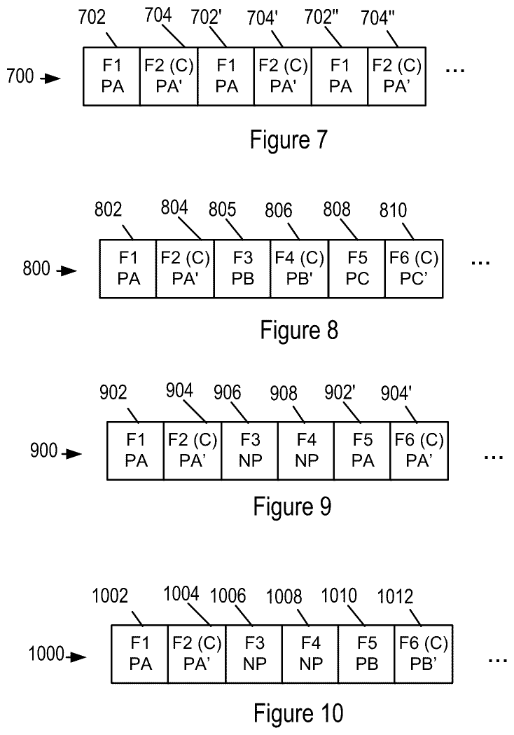

FIGS. 7-10 show exemplary frame/pattern sequences displayed in some embodiments. Each frame/pattern shown in FIGS. 7-10 is used to illuminate a scene area for 1/60th of a second or less.

FIG. 7 shows a first frame sequence 700 which includes a recurring set of frame patterns PA, PA′ where PA′ is a concealing pattern which is displayed immediately following the display of pattern PA. In illumination frame sequence 700 frame 702 frame F1 is used to display pattern PA while in the next frame 704 frame F2 is used as a concealing frame which displays pattern PA′ which is complementary to pattern PA. The pattern display sequence PA,PA′ continues in frames 702′,704′,702″,704″ onward in the FIG. 7 example.

For depth determination purposes it can be useful to vary the patterns used as the initial pattern and corresponding concealing pattern since a particular pattern may interact poorly with some areas of an environment. FIG. 8 shows a sequence frame pairs (F1 802, F2 804), (F3 803, F4 805) (F6 808, F7 810) which show a sequence of patterns PA, PA′, PB, PB′, PC, PC′ where patterns A, B and C are different and the ′ is used to indicate the corresponding concealing pattern.

For purposes of capturing images of a scene area without a pattern, it can be desirable to interspace one or more images which provide consistent, e.g., non-patterned, illumination. Such images can be desirable for training 2D object detection models which can then be associated with 3D object information obtained by generating a depth map of a scheme area.

FIG. 9 shows an embodiment where a sequence of frames 900 includes frames 906, 908 without a pattern. the non-pattern (NP) frames 906, 908, are used to illuminate a scene area between sets (902, 904), (902′, 904′) of patterned frames. The non-patterned frames 906, 908 allow images of the illuminated scheme area to be captured free of the patterns PA, PA′ used in other frame times. A non-patterned captured image can be preferable to generating a composite image from images captured in sequential patterned frame times 902, 904 because more camera movement is likely to occur over a pair of sequential frames than during a single frame time. To avoid a human perceiving the change from a patterned frame to a non-patterned frame the light output corresponding to individual pixels of the NP frame may be reduced to half the light output of “on” pixels of the patterned frames or display time of the non-patterned frame could be halved compared to the patterned frame.

In this way a uniform consistent illumination will be perceived by a human viewer even though a change is made from use of a pattern frame to illuminate an area to a non-patterned frame.

The concept of using different patterns interspaced with non-patterned frames for illumination purposes is shown by the exemplary frame sequence 1000 of FIG. 10. The patterned frame pair (F1 1002, F2 1004) which display the pattern sequence PA, PA, is followed by non-pattern frames F3 1006, F4 1008 which are then followed by the patterned frame sequence F5 1010, F6 1012 which have different patterns than the frames F1 1002, F2 1004.

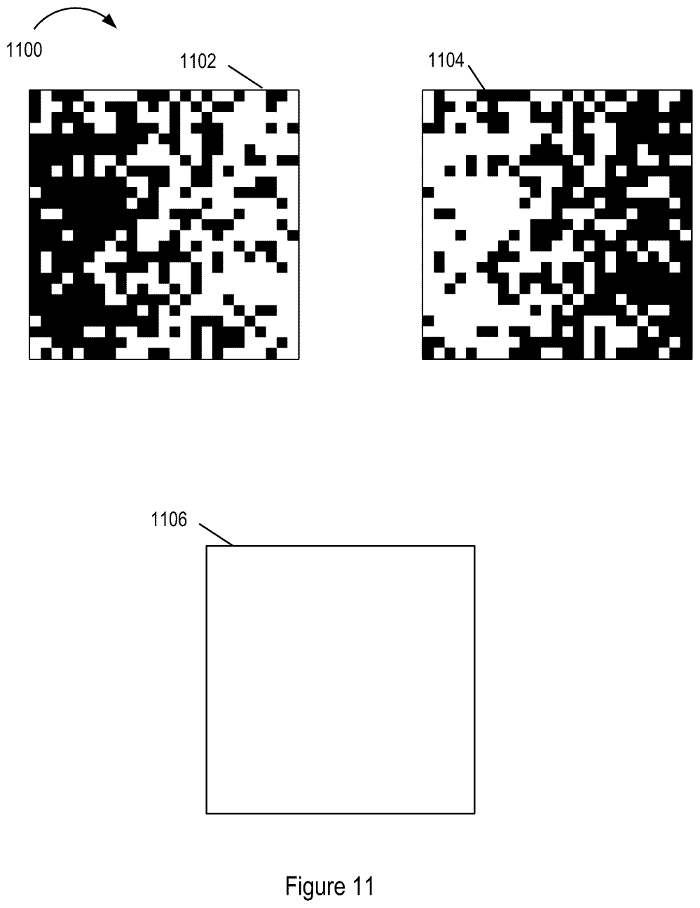

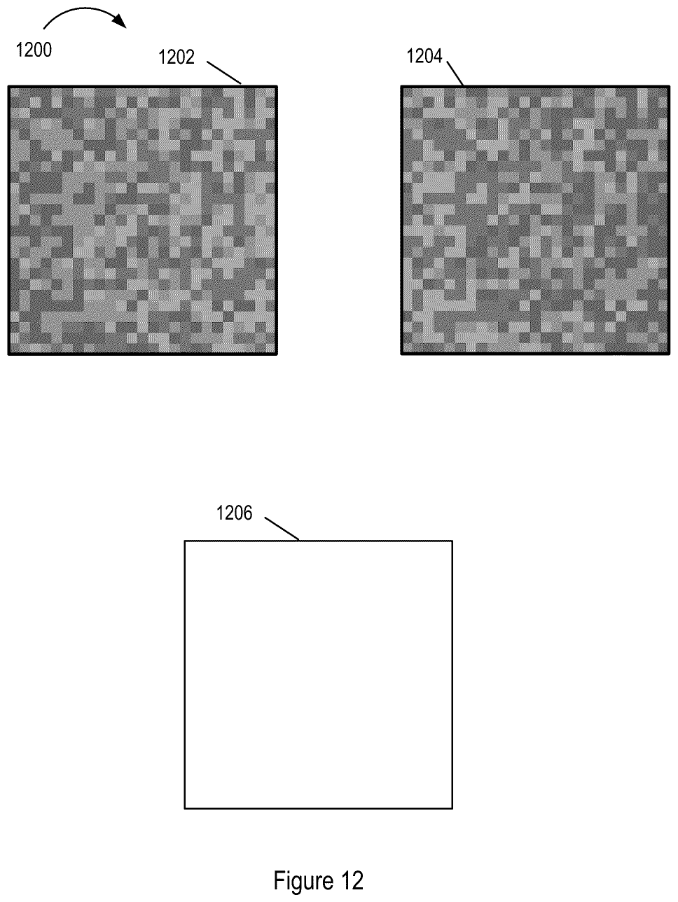

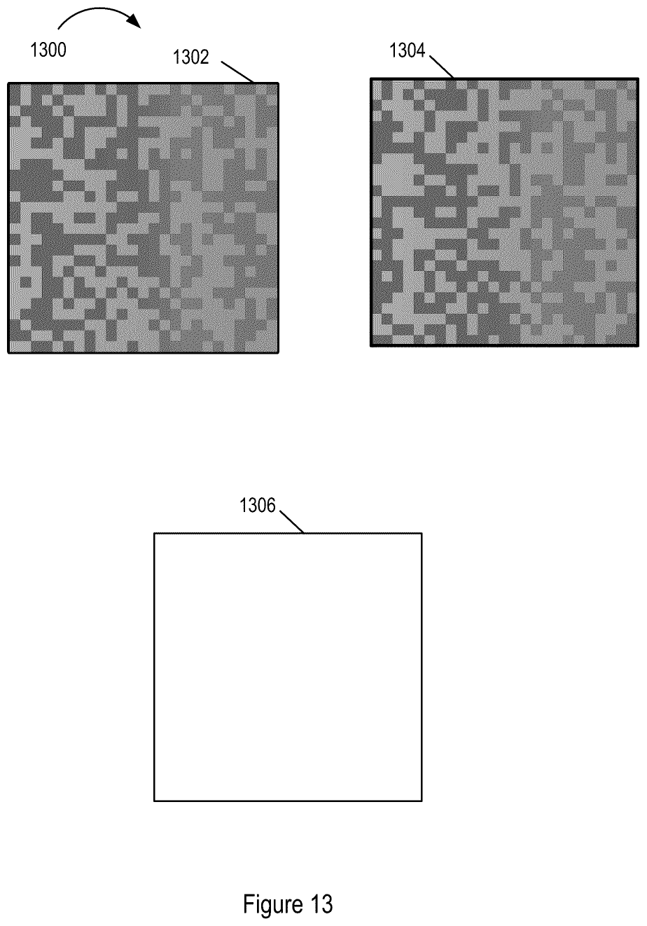

Various additional exemplary illumination patterns and features of such patterns will now be discussed with regard to the examples shown in FIGS. 11 to 13.

FIG. 11 is a diagram 1100 showing a first BW pattern 1102 and corresponding concealing pattern 1104 which when viewed by a human sequentially will result in a perceived uniform illumination as represented by block 1106.

The FIG. 11 example is an example of the use of a monochrome B/W pattern in patterned image 1102 where the average intensity varies from 25% to 75% from left to right in the image. In the corresponding concealing image 1104 the average intensity will vary in the opposite direction from right to left.

For a color image, the intensity gradient included in the initial patterned image and its concealing complement can be in one or more color channels where the R, G and B components of each pixel can be treated as an independent color channel.

FIG. 12 is a diagram 1200 showing an example with a color gradient in the initial pattern 1202 and corresponding concealing pattern 1204. In the pattern shown in frame 1202 the average intensity of the blue channel varies from 25% to 75% from left to right edge while the red and green channels only provide texture, no gradient. For the concealing image pattern 1204 the variation in the blue channel is 75% to 25% “on” with the red and green channels providing texture but no gradient. As should be appreciated the color of each pixel or group of pixels corresponding to a square is the result of all three color channels (R,G,B) used to control and thus determine the color of the pixel area represented by the square.

It is also possible to use a pattern with a color gradient where there is no gradient in intensity. FIG. 13 is a diagram 1300 showing an example with a color gradient is included in the initial pattern 1302 and corresponding concealing pattern 1304. In both patterns 1302, 1304 there is no gradient in intensity. To a human viewer the sequential display of patterns 1302, 1304 will result in a consistent illumination pattern as shown in block 1306.

As discussed above, in various embodiments the consecutive display of images for a short period of time is so that the images are not separately perceivable to the human eye. The second image pattern serves to conceal or hide the first image pattern when viewed by a human viewer. In combination the first and second images when shown sequentially, appear to a viewer in at least some cases as a uniform or generally uniform illumination of an area. For successful pattern concealment from a human viewer the concealing pattern need not be a perfect complementary match to the initial pattern used for illumination purposes. This is particularly the case when non-pattern frames are included in the frame sequence with pattern and corresponding concealing frame pairs.

In some embodiments, slight non-uniformities in each pixel's time-average intensity might be acceptable To achieve pattern concealment, the initial and concealing patterns, when combined, should add up to a uniform intensity but some variation may be acceptable.

As discussed above in some embodiments the second concealing image may not fully mask the pattern of the first image from a human viewer but may and sometimes does conceal the first image pattern to an extent that the combination of first and second image patterns, when viewed sequentially by a human viewer will not be distracting to the viewer.

In at least some embodiments the first image and second image are complementary images which, when viewed sequentially, appear to a viewer as providing uniform or generally uniform illumination, e.g., of an area upon which the first and images are projected. In at least one exemplary embodiment the first and second images are inverses of each other with the first and second images being monochrome images. In one such embodiment white or “on” pixels in the first image correspond to black or “off” pixels in the second image and black or “off” pixels in the first image correspond to “on” pixels in the second image.

In various embodiments the first image and concealing image are output and thus displayed/projected sequentially. In some such cases the first and second image patterns are displayed consecutively with each of the first and second images being displayed for a fraction of a second, e.g., 1/60th of a second or less so that a human will not perceive them as separate images.

The first and second images maybe and sometimes are presented as part of a video sequence output by the illumination device 108. The video sequence is projected with the images, e.g., frames, of the video sequence being projected at a consistent frame rate, e.g., 1/60 or 1/120 of a second. While the video sequence includes recurring first and second images in some embodiments

In various embodiments the images are preselected or designed so that a human viewer will perceive the sequentially displayed images as providing a uniform or generally uniform illumination of an area without a noticeable pattern being visible to the naked human eye. While the pattern in each of the images is not visible to a human since it is displayed for a short time and followed by a concealing image, the images with patterns can be captured by one or more cameras, e.g., stereoscopic camera pairs, and used for depth determination purposes.

In some embodiments the first images a random or pseudo random pattern and the concealing pattern is a complementary image of the pattern in the first image which when viewed after the first image gives a human viewer an impression of a uniform or nearly uniform light output being used to illuminate an area. In some cases, the concealing image is the complementary image used as the concealing image is the inverse of the pattern in the first image.

While some embodiments rely on monochrome e.g., black and white illumination patterns, other embodiments use color patterns. In the case of black and white images, the second/concealing image would include pixels of opposite values to the values included at the corresponding pixel locations of the first image. Thus, pixels that were black in the first frame are white in the second concealing frame which is displayed consecutive to the first frame and pixels that were white in the first frame are black in the second concealing frame. There are many patterns that can be used in accordance with the invention use. Random noise patterns are used in some embodiments.

In one such embodiment in a first image, each block is randomly assigned the original color or the complementary color with equal probability. The random noise pattern minimizes the likelihood of a random match and the choice of complementary colors maximizes the contrast. The color pattern also reduces the likelihood of a random match (needs to match all 3 channels rather than just 1) compared to a monochrome pattern.

In one color embodiment a color pattern is used for the first frame and for the second concealing frame which is consecutive to the first frame, the pattern is inverted, and in the color example, red pixels (R=255, G=0, B=0) are flipped with the complementary color cyan (R=0, G=255, B=255). These two frames alternate at high frequency so the pattern gets evened out by its inverse over time.

A color image can be constructed wherein each color channel, (e.g., R channel, G channel, B channel) or combination of color channels has the properties described of a monochrome image channel, e.g., luminance channel. Each color channel of a color image can have a noise pattern, gradient, or both in the same manner that a monochrome image can have a noise pattern, gradient, or both.

In some embodiments the light projection device 108 is an illumination device that is a narrow aperture illumination source where rays reaching a point in space are originating from a very small set of angles (e.g., have a unique/nearly unique origin). In the extreme, this is a perfectly collimated source where the rays are parallel.

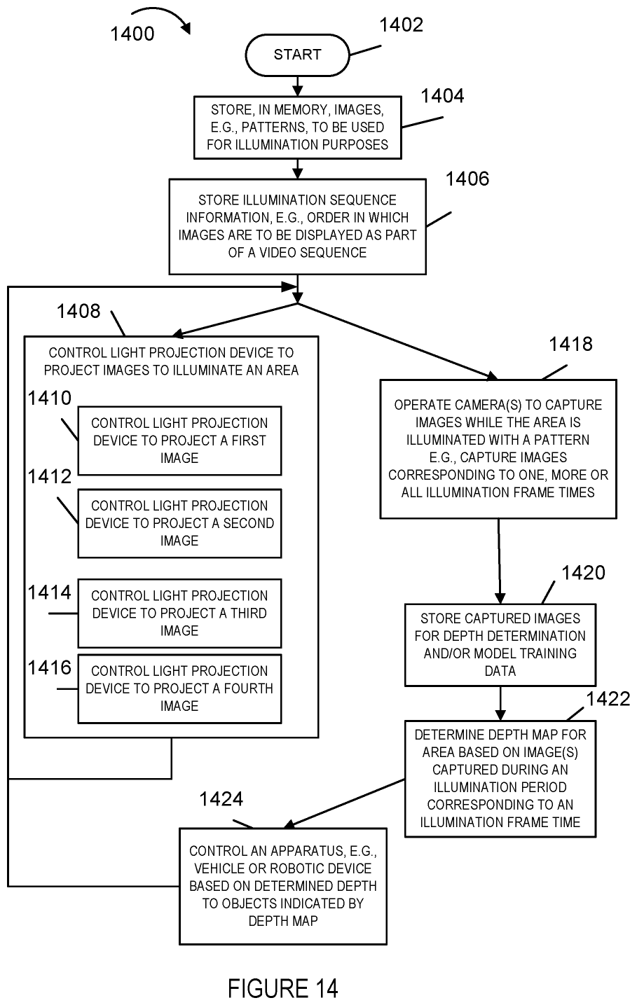

FIG. 14 shows a flow chart 1400 of a method implemented in accordance with the invention involving illumination and depth determination based on captured images of an illuminated area. The method 1400 starts in start step 1402 with an apparatus, e.g., apparatus 104 being powered on. Operation proceeds from start step 1402 to step 1404 in which images, e.g., patterns, to be used for illumination purposes are stored in memory 204, e.g., as part of illumination information 1053. The stored images/patterns maybe, e.g., the patterns shown in any of FIGS. 4-6 and 11-13.

Then in step 1406 illumination sequence information is stored in the memory 204. The illumination sequence information includes information on the sequence in which images are to be displayed by the illumination device 108 and/or 109. The image sequence information may indicate any of the sequences shown in FIGS. 7 to 10 for example but other sequences are also possible. With the sequence information stored and available it is used in combination with the stored image information by processor 202 to control the illumination device 108 and/or 109 to project a sequence of images in accordance with a stored illumination pattern. In step 1408 the processor 202 controls the illumination device(s) 108 and/or 109 to project images as part of a video sequence, e.g., with each image being projected for 1/60th of a second or less in some embodiments. Step 1408 includes steps 1410, 1412, 1414 and 1416 in some embodiments. In step 1410 a first image is projected by the light projection device(s) 108. This is followed by projection of a second image in step 1412. The projection of the second image is followed in some embodiments by projection of a third image in step 1414 and then a fourth image in step 1416. In some embodiments the first and second images are complimentary images with the second image working to conceal from a human observer the pattern displayed in the first image. In some embodiments the third and fourth images are a second pair of complimentary images. The second pair of complimentary images can be the same or different from the first pair of images. In some embodiments the third and forth images are not complimentary images but rather uniform images which are used to provide uniform illumination to allow images for object recognition training purposes to be captured without a pattern being present.

As images are displayed by the illumination device 1408 they are captured in step 1418 by one camera or in most cases multiple cameras 114, 116. The captured images are stored in memory 204 in step 1420. In step 1422 captured images corresponding to a displayed pattern are used for depth determination purposes. For example a set of images corresponding to display of the first image are compared and stereoscopic depth determinations are made to generate a depth map indicating distances from a reference camera to detected objects, e.g., with each pixel of the depth map indicating a distance from a reference camera used to capture a reference image to a detected surface corresponding to a pixel value in the depth map.

With a depth map having been determined in step 1422 operation proceeds to step 1424 in which an apparatus is controlled based on the depth map. The apparatus maybe a robotic device or vehicle which is controlled to move to pick up a detected object, avoid an object take some other action based on the determined depth information.

Illumination and image capture occur in parallel on an ongoing basis as is represented by the arrow from step 1408 and 1424 returning to the top of boxes 1408, 1418. Depth maps can be generated from each illumination frame or a subset of illumination frames depending on the embodiment.

Various exemplary numbered embodiments will now be discussed. Numbers which refer to a preceding numbered embodiment in each list of numbered embodiments refers to a preceding numbered embodiment in the same list.

### Exemplary List of Numbered Method Embodiment

Numbered Method Embodiment 1. A method of operating a system including a light projection device (108), the method comprising: projecting, from the light projection device (108), for a fraction of a second, a first image to illuminate an area; and projecting, from the light projection device (108), immediately following projecting the first image, a second image to illuminate the area, said second image being different from said first image and being a complementary image to said first image.

Numbered Method Embodiment 2. The method of Numbered Method Embodiment 1, wherein the projected light is visible light.

Numbered Method Embodiment 3. The method of Numbered Method Embodiment 2, wherein projecting said first image includes projecting the first image for 1/60th of a second or less; and wherein projecting said second image includes projecting the second image for 1/60th of a second or less.

Numbered Method Embodiment 4. The method of Numbered Method Embodiment 2, wherein said first image and said second image, through consecutive display of the first and second images, provide a uniform illumination.

Numbered Method Embodiment 5. The method of Numbered Method Embodiment 4, wherein said first image (402, 502, 602, 1102, 1202, or 1302) is a first pattern including a first set of pixels in a first state and a second set of pixels in a second state; and wherein said second image (404, 504, 604, 1104, 1204, or 1304) is a second pattern in which the first set of pixels in the second image is in the second state and the second set of pixels is in the first state.

Numbered Method Embodiment 6. The method of Numbered Method Embodiment 5, wherein the first and second images are monochrome images.

Numbered Method Embodiment 7. The method of Numbered Method Embodiment 6, wherein the first image and second images are inverses of each other.

Numbered Method Embodiment 8. The method of Numbered Method Embodiment 5, wherein the second image is an inverse image of the first image.

Numbered Method Embodiment 8A. The method of Numbered Method Embodiment 1, where the first image has a noise pattern and the second pattern has a complementary noise pattern in one or more channels or combination of channels in the image.

Numbered Method Embodiment 8B. The method of Numbered Method Embodiment 1, wherein the first image has a gradient in the average local intensity values in one or more channels of the image and the second image has a reverse gradient.

Numbered Method Embodiment 8C. The method of Numbered Method Embodiment 8B, wherein the gradient is a linear gradient in the direction of a stereo baseline.

Numbered Method Embodiment 9. The method of Numbered Method Embodiment 1, wherein said first image (402 or 502)) is a monochrome image comprising a first image frame including a plurality of pixel locations; wherein the first image (402 or 502) includes a first set of first intensity (e.g., white which are full intensity) pixels in a first set of pixel locations and a first set of second intensity (e.g., black which are full off) pixels in a second set of pixel locations; wherein said second image (404 or 504) is a monochrome image comprising a second image frame having the same number of pixels and pixel locations as the first image frame; and wherein the second image (404 or 504) includes a second set of second intensity pixels in the first set of pixel locations in the second image frame and a second set of first intensity pixels in the second set of pixel locations in the second image frame.

Numbered Method Embodiment 10. The method of Numbered Method Embodiment 1, wherein projecting, for a fraction of a second, a first image and projecting, immediately following projecting the first image a second image, includes projecting said first and second images a part of a video sequence having a frame rate of at least 1/60th of a second.

Numbered Method Embodiment 11. The method of Numbered Method Embodiment 10, wherein said video sequence includes a recurring sequence of said first and second images.

Numbered Method Embodiment 12. The method of claim 1 wherein said light projecting device (108) is a Collimated light projecting device which projects visible light.

Numbered Method Embodiment 12A. The method of Numbered Method Embodiment cl wherein said light projecting device (108) is a global scan projection device and wherein the cameras (114, 116) used to capture images each include a global shutter image sensor (e.g., the projection device switches between frames on a global basis and is paired in some embodiments with cameras (114, 116) which each include a global image sensor where the whole sensor is exposed at the same time and does not implement a progressive scan when capturing images).

Numbered Method Embodiment 12B. The method of Numbered Method Embodiment 1 wherein said light projecting device (108) is a progressive scan display device and the cameras used to capture images each include a progressive scan image sensor (e.g., the progressive scan projecting device is associated and synchronized with progressive scan cameras with progressive scan image sensors with illumination and image capture scans being synchronized so that areas are illuminated as the are scanned).

Numbered Method Embodiment 12C. The method of Numbered Method Embodiment 1 wherein said light projecting device (108) is a digital micromirror (DMD) device.

Numbered Method Embodiment 12D. The method of Numbered Method Embodiment 1 wherein the light projection device (108) is located in close proximity, e.g., physically adjacent, to the cameras (114, 116) used for depth determination.

Numbered Method Embodiment 12E. The method of Numbered Method Embodiment 1, wherein the light projection device (108) illuminates the field of view of one or more cameras used to capture images for stereoscopic depth determination.

Numbered Method Embodiment 12F. The method of Numbered Method Embodiment 12E wherein the light projection device (108) and cameras (114, 116) are positioned so that image areas occluded from the field of view of the cameras (114, 116) is also occluded from the area illuminated by the light projection device (108) so that the illumination pattern matches or closely matches the image capture area used for depth determination purposes.

Numbered Method Embodiment 13. The method of Numbered Method Embodiment 12 wherein said collimated light projecting device (108) projects light in a first optical direction which is not perpendicular to vertical or horizontal surfaces included in the illuminated area.

Numbered Method Embodiment 13A. The method of Numbered Method Embodiment 1, wherein the system includes multiple light projection devices (108, 109), the multiple light projection devices (108, 109) including the said light projection device (108) and a second light projection device (109); and wherein the method further includes: projecting, from the second light projection device (109), for a fraction of a second, a third image to illuminate an area, projecting, from the second light projection device (109), immediately following projecting the first image, a fourth image to illuminate the area, said fourth image being different from said third image and being a complementary image to said third image, said third and fourth images being the same or different from said first and second images.

Numbered Method Embodiment 13B. The method of Numbered Method Embodiment 1, wherein said light projection device (108) includes multiple separate light emitting devices (103, 105) which, in combination, illuminate a scene area with the multiple separate light emitting devices/elements being used to project said first and second images sequentially.

### Exemplary Numbered System Embodiments

Numbered System Embodiment 1. A system (104) comprising: a light projection device (108); a memory (204) storing a first image and a second image; a processor (202) configured to control the light projection device to:
project, from the light projection device (108), for a fraction of a second, the first image to illuminate an area,
project, from the light projection device (108), immediately following projection of the first image, the second image to illuminate the area, said second image being different from said first image and being a complementary image to said first image.

Numbered System Embodiment 2. The system of Numbered System Embodiment 1, wherein the light projection device (108) is a visible light projector and wherein the projected light is visible light.

Numbered System Embodiment 3. The system of Numbered System Embodiment 2, the processor (202) is configured, as part of being configured to control the projection device (108) to: control the projection device (108) to project the first image for 1/60th of a second or less and then to project the second image for 1/60th of a second or less.

Numbered System Embodiment 4. The system of Numbered System Embodiment 2, wherein said first image and said second image, through consecutive display of the first and second images, provide a uniform illumination.

Numbered System Embodiment 5. The system of Numbered System Embodiment 4, wherein said first image (402, 502, 602, 1102, 1202, or 1302) is a first pattern including a first set of pixels in a first state and a second set of pixels in a second state; and wherein said second image (404, 504, 604, 1104, 1204, or 1304) is a second pattern in which the first set of pixels in the second image is in the second state and the second set of pixels is in the first state.

Numbered System Embodiment 6. The system of Numbered System Embodiment 5, wherein the first and second images are monochrome images.

Numbered System Embodiment 7. The system of Numbered System Embodiment 6, wherein the first image and second images are inverses of each other.

Numbered System Embodiment 8. The system of Numbered System Embodiment 5, wherein the second image is an inverse image of the first image.

Numbered System Embodiment 8A. The system of Numbered System Embodiment 1, where the first image has a noise pattern and the second pattern has a complementary noise pattern in one or more channels or combination of channels in the image.

Numbered System Embodiment 8B. The system of Numbered System Embodiment 1, wherein the first image has a gradient in the average local intensity values in one or more channels of the image and the second image has a reverse gradient.

Numbered System Embodiment 8C. The system of Numbered System Embodiment 8B, wherein the gradient is a linear gradient in the direction of a stereo baseline.

Numbered System Embodiment 9. The system of Numbered System Embodiment 1, wherein said first image is a monochrome image (402 or 502) comprising a first image frame including a plurality of pixel locations; wherein the first image (402, 502) includes a first set of first intensity (e.g., full intensity) pixels in a first set of pixel locations and a first set of second intensity (e.g., black, full off) pixels in a second set of pixel locations; wherein said second image is a monochrome image comprising a second image frame having the same number of pixels and pixel locations as the first image frame; and wherein the second image includes a second set of second intensity pixels in the first set of pixel locations in the second image frame and a second set of first intensity pixels in the second set of pixel locations in the second image frame.

Numbered System Embodiment 10. The system of Numbered System Embodiment 1, wherein projecting, for a fraction of a second, a second image, immediately following projecting the first image, includes projecting said first and second images as part of a video sequence having a frame rate of at least 1/60th of a second.

Numbered System Embodiment 11. The system of Numbered System Embodiment 10, wherein said video sequence includes a recurring sequence of said first and second images.

Numbered System Embodiment 12. The system of Numbered System Embodiment 1 wherein said light projecting device (108) is a Collimated light projecting device which projects visible light.

Numbered System Embodiment 12A. The system of Numbered System Embodiment 1, wherein said light projecting device (108) is a global scan projection technology device and wherein the cameras used to capture images each include a global shutter image sensor (e.g., a projection device which performs switches between displayed frames on a global basis is paired in some embodiments with cameras with a global image sensor where the whole sensor is exposed at the same time).

Numbered System Embodiment 12B. The system of Numbered System Embodiment 1, wherein said light projecting device (108) is a progressive scan display technology device and the cameras (114, 116) used to capture images each include a progressive scan image sensor (e.g., in such a case the progressive scan projecting device is paired with progressive scan cameras with the light projecting device 108 illuminating the scan area in a synchronized manner with the capture of the scene area by the progressive scan image sensors of the cameras being used to capture images).

Numbered System Embodiment 12C. The system of Numbered System Embodiment 1 wherein said light projecting device (108) is a digital micromirror (DMD) device.

Numbered System Embodiment 12D. The system of Numbered System Embodiment 1 wherein the light projection device (108) is located in close proximity to the cameras used for depth determination.

Numbered System Embodiment 12E. The system of Numbered System Embodiment 1, wherein the light projection device (108) illuminates the field of view of one or more cameras (114, 116) used to capture images for stereoscopic depth determination.

Numbered System Embodiment 12F. The system of Numbered System Embodiment 12E wherein the light projection device (108) and cameras (114, 116) are positioned so that image areas occluded from the field of view of the cameras (114, 116) are also occluded from the area illuminated by the light projection device (108) so that the illumination pattern area matches or closely matches the image capture area used for depth determination purposes.

Numbered System Embodiment 13. The system (104) of Numbered System Embodiment 12 wherein said light projecting device (108) which in some but not all embodiments is a collimated light projecting device, projects light in a first optical direction which is not perpendicular to vertical or horizontal surfaces included in the illuminated area.

Numbered System Embodiment 13A. The system (104) of Numbered System Embodiment 1, wherein the system includes multiple light projection devices (108, 109), the multiple light projection devices (108) including the said light projection device (108) and a second light projection device (109); and wherein the processor (202) further controls second light projection device (109) to:
project, from the second light projection device (109), for a fraction of a second, a third image to illuminate an area,
project, from the second light projection device (109), immediately following projecting the first image, a fourth image to illuminate the area, said fourth image being different from said third image and being a complementary image to said third image, said third and fourth images being the same or different from said first and second images.

Numbered System Embodiment 13B. The system of Numbered System Embodiment 1, wherein said light projection device (108) includes multiple separate light emitting devices (103, 105) which, in combination, illuminate a scene area with the multiple separate light emitting elements being used to project said first and second images.

Numerous additional variations on the methods and apparatus of the present invention described above will be apparent to those skilled in the art in view of the above description of the invention.

Some aspects and/or features are directed a non-transitory computer readable medium embodying a set of software instructions, e.g., computer executable instructions, for controlling a computer or other device, e.g., a vehicle or robotic device, to operate in accordance with the above discussed methods.

The techniques of various embodiments may be implemented using software, hardware and/or a combination of software and hardware. Various embodiments are directed to a control apparatus, e.g., controller or control system, which can be implemented using a microprocessor including a CPU, memory and one or more stored instructions for controlling a device or apparatus to implement one or more of the above described steps. Various embodiments are also directed to methods, e.g., a method of controlling a vehicle or drone or remote control station and/or performing one or more of the other operations described in the present application. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above various features of the present invention are implemented using modules and/or components. Such modules and/or components may, and in some embodiments are, implemented as software modules and/or software components. In other embodiments the modules and/or components are implemented in hardware. In still other embodiments the modules and/or components are implemented using a combination of software and hardware. In some embodiments the modules and/or components are implemented as individual circuits with each module and/or component being implemented as a circuit for performing the function to which the module and/or component corresponds. A wide variety of embodiments are contemplated including some embodiments where different modules and/or components are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a vehicle which implements one or more of the steps of the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed is:

1. A method of operating a system including a light projection device, the method comprising:
projecting, from the light projection device, for a fraction of a second, a first image to illuminate an area, and
projecting, from the light projection device, immediately following projecting the first image, a second image to illuminate the area, said second image being different from said first image and being a complementary image to said first image.

2. The method of claim 1, wherein the projected light is visible light.

3. The method of claim 2,
wherein projecting said first image includes projecting the first image for 1/60^{th} of a second or less; and
wherein projecting said second image includes projecting the second image for 1/60^{th} of a second or less.

4. The method of claim 2, wherein said first image and said second image, through consecutive display of the first and second images, provide a uniform illumination.

5. The method of claim 4,
wherein said first image is a first pattern including a first set of pixels in a first state and a second set of pixels in a second state; and
wherein said second image is a second pattern in which the first set of pixels in the second image is in the second state and the second set of pixels is in the first state.

6. The method of claim 5, wherein the first and second images are monochrome images.

7. The method of claim 6, wherein the first image and second images are inverses of each other.

8. The method of claim 5, wherein the second image is an inverse image of the first image.

9. The method of claim 1,
wherein said first image is a monochrome image comprising a first image frame including a plurality of pixel locations;
wherein the first image includes a first set of first intensity (e.g., full intensity) pixels in a first set of pixel locations and a first set of second intensity (e.g., black, full off) pixels in a second set of pixel locations;
wherein said second image is a monochrome image comprising a second image frame having the same number of pixels and pixel locations as the first image frame; and
wherein the second image includes a second set of second intensity pixels in the first set of pixel locations in the second image frame and a second set of first intensity pixels in the second set of pixel locations in the second image frame.

10. The method of claim 1, wherein projecting, for a fraction of a second, a first image and projecting, immediately following projecting the first image includes projecting said first and second images a part of projecting a video sequence having a frame rate of at least 1/60^{th} of a second.

11. The method of claim 6, wherein said video sequence includes a recurring sequence of said first and second images.

12. The method of claim 1 wherein said light projecting device is a Collimated light projecting device which projects visible light.

13. The method of claim 12 wherein said collimated light projecting device projects light in a first optical direction which is not perpendicular to vertical or horizontal surfaces included in the illuminated area.

14. A system comprising:
a light projection device;
a memory storing a first image and a second image;
a processor configured to control the light projection device to:
project, from the light projection device, for a fraction of a second, the first image to illuminate an area,
project, from the light projection device, immediately following projection of the first image, the second image to illuminate the area, said second image being different from said first image and being a complementary image to said first image.

15. The system of claim 14, wherein the light projection device is a visible light projector and wherein the projected light is visible light.

16. The system of claim 15, the processor is configured, as part of being configured to control the projection device to:
control the projection device to project the first image for 1/60^{th} of a second or less and then to project the second image for 1/60^{th} of a second or less.

17. The system of claim 15, wherein said first image and said second image, through consecutive display of the first and second images, provide a uniform illumination.

18. The system of claim 17,
wherein said first image is a first pattern including a first set of pixels in a first state and a second set of pixels in a second state; and
wherein said second image is a second pattern in which the first set of pixels in the second image is in the second state and the second set of pixels is in the first state.

19. The system of claim 14,
wherein said first image is a monochrome image comprising a first image frame including a plurality of pixel locations;
wherein the first image includes a first set of first intensity pixels in a first set of pixel locations and a first set of second intensity pixels in a second set of pixel locations;
wherein said second image is a monochrome image comprising a second image frame having the same number of pixels and pixel locations as the first image frame; and
wherein the second image includes a second set of second intensity pixels in the first set of pixel locations in the second image frame and a second set of first intensity pixels in the second set of pixel locations in the second image frame.

20. The system of claim 14, wherein projecting, for a fraction of a second, a first image and projecting, immediately following projecting the first image includes projecting said first and second images is performed as part of projecting a video sequence having a frame rate of at least 1/60^{th} of a second.
